(19) United States
(12) Patent Application Publication
(10) Pub. No.: US 2005/0194714 A1
(43) Pub. Date: Sep. 8, 2005

(54) Method for forming a vessel

(76) Inventors: Randall W. Nish, Provo, UT (US); Daniel C. Kennedy II, Salt Lake City, UT (US); Douglas J. Murphy, Auburn, IN (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/993,914

(22) Filed: Nov. 19, 2004

Related U.S. Application Data
(60) Provisional application No. 60/523,967, filed on Nov. 21, 2003.

(51) Int. Cl. B29C 41/04

(52) U.S. Cl. 264/255; 264/310

(57) ABSTRACT

A method for forming a vessel includes disposing an attachment portion of a bondable layer against at least a portion of an inner surface of a mold shaped to form a substantial enclosure. The bondable layer can include a fibrous material. A plastic material can be introduced into the mold. The mold can be rotated and the plastic material heated to cause the plastic material to conform to the mold to form a substantial enclosure, and embed into an exposed portion of the bondable layer or fibrous material in the mold to attach the bondable layer to the substantial enclosure. The substantial enclosure with the bondable layer is removed from the mold, and another item, such as a fiber with a resin matrix, is bonded to the bondable layer with the bondable layer forming an intermediate layer.

Benefit of U.S. Provisional Patent Application Ser. No. 60/523,967, filed Nov. 21, 2003, is claimed.

### BACKGROUND OF THE INVENTION

1. Field of the Invention

The present invention relates generally to a method of forming vessels, such as reinforced, rotomolded plastic vessels.

2. Related Art

Rotomolded storage tanks are used in various industries, such as chemical, industrial, aerospace, marine, and oil and gas industries. Plastic materials are often used to manufacture such tanks, particularly in aeronautical and deep-sea applications. The plastic material allows for the production of tanks that are watertight, lightweight, and of relatively low cost. It is often necessary, however, to reinforce these tanks so that they are strong enough to withstand structural loads due to the weight of the contents, operating pressures and temperatures, environmental conditions, etc.

Applying reinforcement material to these tanks can be problematic because most thermoplastics, and especially polyolefins, have very low surface energies that make it difficult or impossible to create a structural bond between the vessel wall and the reinforcing material.

### SUMMARY OF THE INVENTION

It has been recognized that it would be advantageous to develop a method for forming a vessel, or a reinforced vessel, that is lightweight, yet able to withstand structural loads due to the weight of the contents, operating pressures and temperatures, and/or environmental conditions, etc. In addition, it has been recognized that it would be advantageous to develop a method for reinforcing a plastic vessel. Furthermore, it has been recognized that it would be advantageous to develop a method for reinforcing a chemically inert vessel with a fiber and resin composite material.

The invention provides a method for forming a vessel or a reinforced vessel. A bondable layer is disposed against an inner surface of a mold shaped to form a substantial enclosure. A plastic material is introduced into the mold. The mold is rotated and the plastic material heated causing the plastic material to 1) conform to the mold to form a substantial enclosure, and 2) embed into an exposed portion of the bondable layer to attach the bondable layer to the substantial enclosure. The substantial enclosure is removed with the bondable layer from the mold.

In accordance with a more detailed aspect of the present invention, another item, such as a fiber in a resin matrix, can be attached to the bondable layer.

In accordance with a more detailed aspect of the present invention, the bondable layer can include a fibrous material.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIGS. 1a-4e are various schematic views of a method for forming a vessel in accordance with an embodiment of the present invention;

FIG. 1a is a perspective view of a mold shown in an open configuration;

FIG. 1b is a partial, cross-sectional side view of the mold of FIG. 1a;

FIG. 2a is a perspective view of the mold with a bondable layer on an inner surface thereof and a plastic material being introduced therein;

FIG. 2b is a partial, cross-sectional side view of the mold with a bondable layer therein of FIG. 2a;

FIG. 3a is a perspective view of the mold movably disposed in an oven;

FIG. 3b is a partial, cross-sectional side view of the mold with the bondable layer and a plastic material or inner layer conformed to the mold and embedded into the bondable layer;

FIG. 4a is a perspective view of a substantial enclosure with the bondable layer with a reinforcement layer being formed thereon;

FIG. 4b is a partial, cross-sectional side view of the substantial enclosure with the bondable layer of FIG. 4a;

FIG. 4c is an enlarged, partial, cross-sectional side view of the substantial enclosure with the bondable layer of FIG. 4b;

FIG. 4d is a partial, cross-sectional side view of the substantial enclosure with the bondable layer with the reinforcement layer of FIG. 4a; and

FIG. 4e is an enlarged, partial, cross-sectional side view of the substantial enclosure with the reinforcement layer of FIG. 4d.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As illustrated in FIG. 4e, a method for forming a vessel, indicated at 10, in accordance with the present invention is shown. The vessel 10 can form or include a substantial enclosure 14, such as a tank, container, etc. Such vessels can be utilized in chemical, industrial, aerospace, marine, and oil and gas industries, and can be used to hold or contain various different materials and liquids, including for example, water, oil, gasoline, or other chemicals. The vessel 10 can include a chemically inert material, such as a thermoplastic, or polyolefin. Thus, the vessel can be watertight, lightweight, and of relatively low cost. In addition, the vessel 10 can be reinforced, or can be a reinforced vessel, so that the vessel can be strong enough to withstand structural loads due to the weight of the contents, operating pressures and temperatures, environmental conditions, etc. The vessel 10 can be reinforced by a reinforcement layer 18, such as a fiber and resin composite material.

As described above, applying a reinforcement material to a vessel can be problematic because a chemically inert material of the vessel can have a very low surface energy that makes it difficult or impossible to create a structural bond between the vessel and the reinforcing material. Thus, the reinforcement can fail to sufficiently attach, or can later delaminate. Therefore, the vessel 10 or substantial enclosure 14 advantageously includes a bondable layer or intermediate layer 22 disposed between the substantial enclosure 14 and the reinforcement layer 18. The bondable or intermediate layer 22 can be mechanically coupled to the substantial enclosure 14 and bonded to the reinforcement layer 18. Therefore, the bondable or intermediate layer 22 couples the reinforcement layer 18 to the substantial enclosure 14.

Although the vessel 10 and the substantial enclosure 14 are shown in the Figures as having a cylindrical shape, it will be appreciated that they can have any desired shape. For example, the vessel 10 and the substantial enclosure 14 can be square, rectangular, circular, spherical, pie-shaped, etc. The term “substantial enclosure” is used herein to describe an enclosure shaped to hold or contain a material, such as liquid, and can be shaped as a bowl, tank, container, etc. The substantial enclosure 14 can include an opening therein, and can be sealable, such as with a lid or cap. Thus, the substantial enclosure can be watertight. The material for the substantial enclosure can include plastic, thermoplastic, polyolefin, polyethylene, polypropylene, polyurethane, etc. The substantial enclosure 14 can form an inner layer, and inner surface 24, of the vessel 10.

The bondable layer 22 can include a fibrous material with a plurality of fibers 26. Examples of the fibrous material include a fiber fabric, cloth, weave or mat. The fibers 26 can be configured in various different orientations. For example, the fibers 26 can be provided in a weave with fibers disposed in transverse orientations, weaving back and forth and overlapping other fibers. As another example, the fibers 26 can be provided in chopped strands. In addition, the bondable layer 22 or fibrous material can have a thickness formed by numerous overlapping fibers. The bondable layer 22 can have an inner side 30 and an outer side 34. The fibers 26 can extend between the inner and outer sides 30 and 34. The bondable layer 22 or fiber 26 can include graphite, fiberglass, etc.

The reinforcement layer 18 can include a fiber in a resin matrix 38. The fiber of the reinforcement layer 18 can include continuous fibers wrapped around the substantial enclosure 14. The fiber can be graphite, fiberglass, etc.

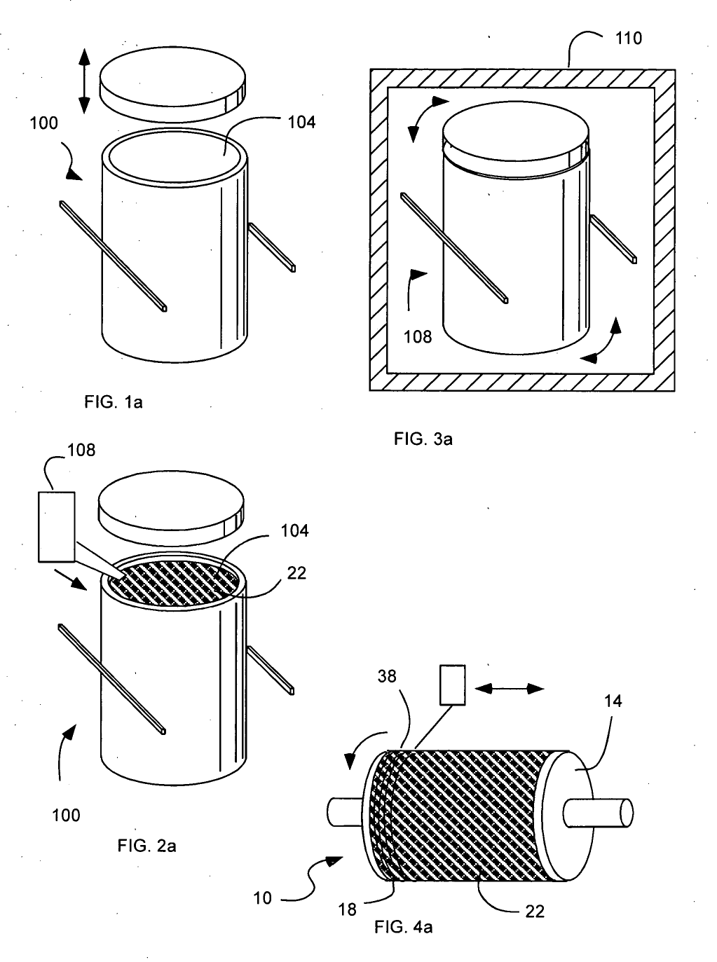

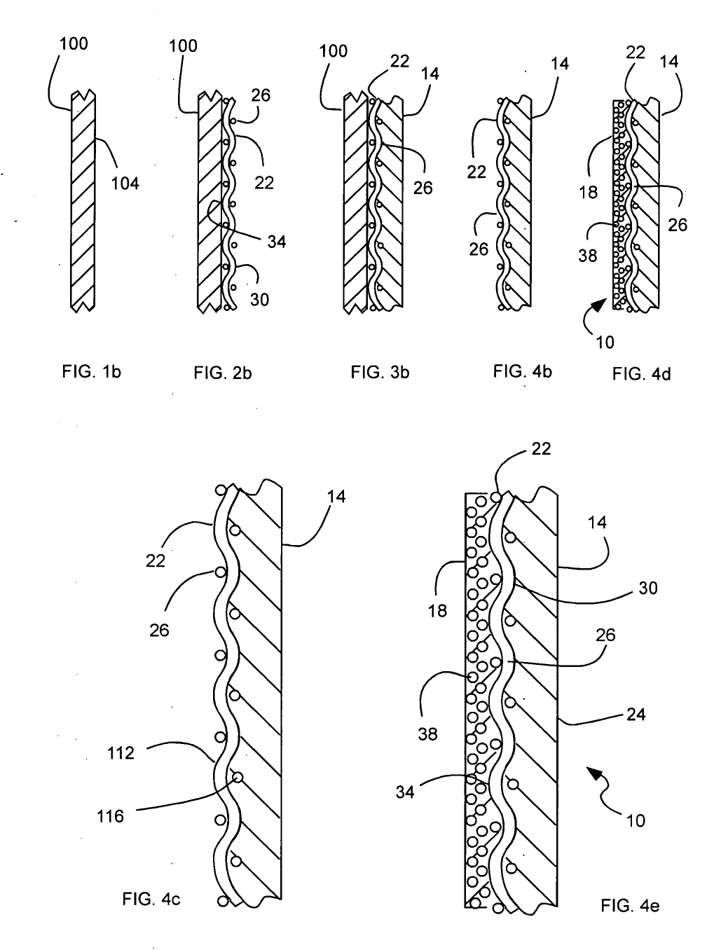

Referring to FIGS. 1a and 1b, a mold 100 with an inner surface 104 is shown for forming the substantial enclosure 14. The mold 100 and the inner surface 104 can be shaped to form the substantial enclosure 14. The mold 100 can be provided in sections or halves that can be combined together to form the mold. The mold 100 can be sealed or completely enclosed. As shown, the mold 100 can have a main section with a lid releasably securable to the main section. The mold 100 can be formed of heat tolerant material, such as aluminum, plain carbon steel and stainless steel, as is known in the art.

Referring to FIGS. 2a and 2b, the bondable layer 22 is disposed on the inner surface 104 of the mold 100. The outer side 34 of the bondable layer 22 can be an attachment portion or side secured to the inner surface 104. The inner side 30 of the bondable layer 22 can be an exposed portion or side that faces into the mold. An example of a means for attaching or securing the bondable layer 22 to the inner surface 104 includes using an adhesive. The bondable layer 22 can be disposed around an entire periphery or circumference of the mold 100. For example, the bondable layer can be disposed in a cylindrical sleeve or jacket. Alternatively, the bondable layer can be disposed around an entire inner surface of the mold, so that the bondable layer surrounds the entire, or substantially the entire, enclosure 14. For example, the bondable layer can be disposed in a cylindrical shell with a top and bottom. Alternatively, the bondable layer can be disposed in separate and discrete patches at desired locations.

Referring to FIG. 2a, a plastic material 108 can be introduced into the mold 100. The plastic material 108 can be provided in predetermined or premeasured amount of plastic molding material. The plastic material can be provided as pellets or granules. The mold 100 can then be closed or sealed. Referring to FIG. 3a, the mold 100 with the plastic material therein can be disposed in an oven 110. The plastic material can be interspersed throughout the mold by rotating the mold. In addition, the plastic material can be simultaneously heated by the oven 110. The mold 100 can be rotated about multiple axes. The plastic material melts and forms a pool of liquid plastic resin as the oven heats the plastic material. The multiaxial rotational movement causes the plastic material to be evenly distributed throughout the mold, resulting in a substantial enclosure having a substantially constant wall thickness. As the mold rotates, the plastic material adheres as a film to the interior surface of the mold, and/or the exposed portion 30 of the bondable layer 22. Plastic material will continue to adhere to this film as the mold rotates, such that a plastic layer will result which forms the wall of the substantial enclosure. Heating and multiaxial rotation are continued until the wall of the substantial enclosure is sufficiently thick and until the substantial enclosure is fully formed. The plastic film or material will harden as the mold cools, such as by removing the mold from the oven. The mold can continue to be rotated as it cools to ensure consistent wall thickness. Air, water spray, or a combination of the two can be used to cool the mold. The mold can be opened and the substantial enclosure removed. The molding process can form a substantial enclosure that is seamless and hollow, and with a substantially constant wall thickness.

Rotating and heating the mold 100 and the plastic material 108 causes the plastic material 108 to conform to the mold 100, and to form the substantial enclosure 14. In addition, heating the plastic material 108 causes the plastic material to embed into the exposed portion 30 of the bondable layer 22 on the inner surface 104 of the mold 100. The molten plastic material permeates into a thickness of the bondable layer, and embeds into the fibrous material and around individual fibers or portions of individual fibers. The plastic material can substantially surround portions of the fiber, forming a mechanical attachment. For example, individual fibers can weave back and forth, into and out of the plastic material, indicated at 112 in FIG. 4c. As another example, entire fibers of a mat or weave can be embedded within the plastic material, indicated at 116 in FIG. 4c. The embedded plastic attaches, or mechanically attaches, the bondable layer 22 to the substantial enclosure 14. Thus, the bondable layer 22 or fibrous material is integrally molded into the substantial enclosure 14 or plastic material thereof. Furthermore, heating and rotating causes the plastic material to form an inner layer of the substantial enclosure 14 or vessel 10. The bondable layer 22 forms a layer around at least a portion of the inner layer.

While the exposed portion 30 of the bondable layer 22 is embedded into the plastic material of the substantial enclosure 14, the attachment portion 34 of the bondable layer becomes exposed when removed from the mold. The bondable layer 22, attached to the substantial enclosure 14 or inner layer, allows other items to be secured to the substantial enclosure 14 by attaching to the bondable layer, or attachment portion 34 thereof. Referring to FIGS. 4a-e, the other items can include a reinforcement layer 18, such as a fiber in a resin matrix. Thus, the bondable layer 22 can form an intermediate layer between the other item or reinforcement layer 18, and the substantial enclosure 14 or inner layer. The reinforcement layer 18 can extend around a periphery or circumference of the substantial enclosure 14. For example, fiber can be continuously wound around the substantial enclosure 14 and the bondable layer 22. The fiber and resin can bond to the fibrous material of the bondable layer. Thus, the reinforcement layer 18 can bond to the bondable layer 22, while the bondable layer can be mechanically attached to the substantial enclosure 14 or inner layer.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

1. A method for forming a vessel, comprising the steps of:
a) disposing a bondable layer against an inner surface of a mold shaped to form a substantial enclosure;
b) introducing a plastic material into the mold;
c) rotating the mold and heating the plastic material causing the plastic material to i) conform to the mold to form a substantial enclosure, and ii) embed into an exposed portion of the bondable layer to attach the bondable layer to the substantial enclosure; and
d) removing the substantial enclosure with the bondable layer from the mold.

2. A method in accordance with claim 1, wherein the step of rotating the mold and heating the plastic material further causes the plastic material to form an inner layer of the substantial enclosure, and the bondable layer to form a layer around at least a portion of the inner layer.

3. A method in accordance with claim 1, wherein the step of rotating the mold and heating the plastic material further causes the plastic material to permeate into a thickness of the bondable layer.

4. A method in accordance with claim 1, wherein the step of disposing a bondable layer includes disposing a bondable layer including a fibrous material; and wherein the step of heating the plastic material includes causing the plastic material to embed into the fibrous material.

5. A method in accordance with claim 1, further comprising the step of:
bonding another item to the bondable layer with the bondable layer forming an intermediate layer between the item and the plastic material.

6. A method in accordance with claim 5, wherein the step of bonding another item to the bondable layer includes bonding a fiber with a resin matrix.

7. A method in accordance with claim 6, wherein the step of bonding a fiber within a resin matrix further includes bonding the fiber around a periphery of the substantial enclosure.

8. A method in accordance with claim 1, wherein the step of rotating the mold and heating the plastic further includes the step of disposing the mold in an oven and rotating the mold in the oven.

9. A method in accordance with claim 1, wherein the step of disposing a bondable layer against an inner surface of a mold further includes disposing the bondable layer around a periphery of the mold.

10. A method in accordance with claim 9, further comprising the step of bonding a fiber with a resin matrix around a periphery of the substantial enclosure.

11. A method for forming a vessel, comprising the steps of:
a) disposing an attachment portion of a bondable layer against at least a portion of an inner surface of a mold shaped to form a substantial enclosure;
b) introducing a plastic material into the mold;
c) rotating the mold and heating the plastic material causing the plastic material to i) conform to the mold to form a substantial enclosure, and ii) embed into an exposed portion of the bondable layer in the mold to attach the bondable layer to the substantial enclosure;
d) removing the substantial enclosure with the bondable layer from the mold; and
e) bonding another item to the bondable layer with the bondable layer forming an intermediate layer between the item and the plastic material.

12. A method in accordance with claim 11, wherein the step of rotating the mold and heating the plastic material further causes the plastic material to permeate into a thickness of the bondable layer.

13. A method in accordance with claim 11, wherein the step of disposing a bondable layer includes disposing a bondable layer including a fibrous material; and wherein the step of heating the plastic material includes causing the plastic material to embed into the fibrous material.

14. A method in accordance with claim 11, wherein the step of bonding another item to the bondable layer includes bonding a fiber with a resin matrix.

15. A method in accordance with claim 14, wherein the step of bonding a fiber within a resin matrix further includes bonding the fiber around a periphery of the substantial enclosure.

16. A method in accordance with claim 11, wherein the step of rotating the mold and heating the plastic further includes the step of disposing the mold in an oven and rotating the mold in the oven.

17. A method in accordance with claim 11, wherein the step of disposing a bondable layer against an inner surface of a mold further includes disposing the bondable layer around a periphery of the mold.

18. A method in accordance with claim 17, further comprising the step of bonding a fiber with a resin matrix around a periphery of the substantial enclosure.

19. A method for forming a vessel, comprising the steps of:
a) disposing a bondable layer including a fibrous material against an inner surface of a mold shaped to form a substantial enclosure;
b) introducing a plastic material into the mold;
c) rotating the mold and heating the plastic material causing the plastic material to i) conform to the mold to form a substantial enclosure, and ii) embed into the fibrous material of an exposed portion of the bondable layer in the mold to attach the bondable layer to the substantial enclosure; and
d) removing the substantial enclosure with the bondable layer from the mold.

20. A method in accordance with claim 19, wherein the step of rotating the mold and heating the plastic material further causes the plastic material to form an inner layer of the substantial enclosure, and the bondable layer to form a layer around at least a portion of the inner layer.

21. A method in accordance with claim 19, wherein the step of rotating the mold and heating the plastic material further causes the plastic material to permeate into a thickness of the bondable layer.

22. A method in accordance with claim 19, further comprising the step of:
bonding another item to the bondable layer with the bondable layer forming an intermediate layer between the item and the plastic material.

23. A method in accordance with claim 22, wherein the step of bonding another item to the bondable layer includes bonding a fiber with a resin matrix.

24. A method in accordance with claim 23, wherein the step of bonding a fiber within a resin matrix further includes bonding the fiber around a periphery of the substantial enclosure.

25. A method in accordance with claim 19, wherein the step of rotating the mold and heating the plastic further includes the step of disposing the mold in an oven and rotating the mold in the oven.

26. A method in accordance with claim 19, wherein the step of disposing a bondable layer against an inner surface of a mold further includes disposing the bondable layer around a periphery of the mold.

27. A method in accordance with claim 26, further comprising the step of bonding a fiber with a resin matrix around an entire circumference of the substantial enclosure.

28. A method for forming a vessel, comprising the steps of:
a) disposing an attachment portion of a bondable layer including a fibrous material against at least a portion of an inner surface of a mold shaped to form a substantial enclosure;
b) introducing a plastic material into the mold;
c) rotating the mold and heating the plastic material causing the plastic material to i) conform to the mold to form a substantial enclosure, and ii) embed into the fibrous material of an exposed portion of the bondable layer in the mold to attach the bondable layer to the substantial enclosure;
d) removing the substantial enclosure with the bondable layer from the mold; and
e) bonding a fiber with a resin matrix to the bondable layer with the bondable layer forming an intermediate layer between the fiber with a resin matrix and the plastic material.

29. A method in accordance with claim 28, wherein the step of disposing a bondable layer against an inner surface of a mold further includes disposing the bondable layer around a periphery of the mold; and wherein the step of bonding a fiber with a resin matrix includes bonding a fiber with a resin matrix around an entire circumference of the substantial enclosure.
